(19) United States
(12) Patent Application Publication
(10) Pub. No.: US 2017/0097656 A1
(43) Pub. Date: Apr. 6, 2017

(54) CONTROLLING A TARGET DEVICE

(71) Applicant: Telefonaktiebolaget LM Ericsson (publ), Stockholm (SE)

(72) Inventors: Ola ANDERSSON, Spånga (SE); Andreas LJUNGGREN, Vällingby (SE)

(21) Appl. No.: 15/125,386

(22) PCT Filed: Mar. 18, 2014
(86) PCT No.: PCT/SE2014/050321

§ 371 Date: Sep. 12, 2016

(51) Int. Cl. G06F 1/16; G06F 3/01

(52) U.S. Cl. CPC G06F 1/163; G06F 3/013

(57) ABSTRACT

It is presented a method for controlling a target device comprising a display. The method performed in a control device includes obtaining a first indication of where a first user, wearing a wearable electronic device, is looking. The first indication is used to determine that the first user is looking at a predefined peripheral area in relation to the display of the target device. A user interface for the target device is responsively displayed. A corresponding control device, target device, wearable electronic device, computer program and computer program product are disclosed.

### TECHNICAL FIELD

The invention relates to a method for controlling a target device, and corresponding control device, target device, wearable electronic device, computer program and computer program product.

### BACKGROUND

User interfaces for target devices such as home entertainment appliances evolve all the time. For example, televisions are typically controlled using infrared (IR) remote controls, where different commands, such as to control volume, channel, etc., are sent from the remote control to the target device using modulation of infrared signals.

Current remote controls, however, can sometimes be cumbersome to use.

US 2013/0069985 discloses a wearable computing device including a head-mounted display (HMD). The HMD is operable to display images superimposed over the field of view. When the wearable computing device determines that a target device is within its environment, the wearable computing device obtains target device information related to the target device. The target device information may include information that defines a virtual control interface for controlling the target device and an identification of a defined area of the target device on which the virtual control image is to be provided. However, the identification and activation of the virtual control interface is complicated and can for example be difficult to control when the virtual control interface is to displayed or not.

### SUMMARY

It is an object to improve the way that target devices are controlled using a wearable electronic device.

According to a first aspect, it is presented a method for controlling a target device comprising a display. The method is performed in a control device and comprises the steps of: obtaining a first indication of where a first user, wearing a wearable electronic device, is looking; determining, using the first indication, that the first user is looking at a predefined peripheral area in relation to the display of the target device; and displaying a user interface for the target device. This provides an intuitive and very convenient way of activating the user interface for the target device.

The method may further comprise the steps of: obtaining a second indication of where the first user is looking; and performing a control action of the target device when the second indication indicates that the first user is looking at a user interface element of the user interface. In other words, the first user can perform control actions by simply looking at a corresponding user interface element. Optionally, the user needs to look at the user interface element for at least a predefined amount of time.

The step of determining that the first user is looking at predefined peripheral area may require that the user is looking at the predefined area more than a threshold amount of time for the determining to yield a positive result. This reduces the risk of unintentional activation of the user interface.

The peripheral area may be an area in the corner of the display of the target device.

The control device may be comprised in the target device, in which case the step of obtaining the first indication may comprise receiving the first indication in a signal from the wearable electronic device.

The step of displaying a user interface may comprise displaying the user interface on the display of the target device. In this way, the wearable electronic device can be kept simple and provided at low cost, since the wearable electronic device in this case does not need to have a display.

The method may further comprise the step of: obtaining at least one further indication of where at least one other user, wearing a wearable electronic device, is looking; in which case the step of displaying the user interface may be configured to only be performed when the first indication differs more than a threshold value from all of the at least one further indications.

The control device may be comprised in the wearable electronic device comprising a display and a front facing camera, in which case the step of obtaining the first indication may comprise determining, using a signal from the front facing camera of the wearable electronic device, where the first user is looking.

The step of displaying a user interface may comprise displaying the user interface on the display of the wearable electronic device.

According to a second aspect, it is presented a control device for controlling a target device comprising a display. The control device comprises: a processor; and a memory storing instructions that, when executed by the processor, causes the control device to: obtain a first indication of where a first user, wearing a wearable electronic device, is looking; determine, using the first indication, that the first user is looking at a predefined peripheral area in relation to the display of the target device; and display a user interface for target device.

The control device may further comprise instructions that, when executed by the processor, causes the control device to: obtain a second indication of where the first user is looking; and to perform a control action of the target device when the second indication indicates that the first user is looking at a user interface element of the user interface.

The instructions to determine that the first user is looking at predefined peripheral area may comprise instructions that, when executed by the processor, causes the control device to require that the user is looking at the predefined area more than a threshold amount of time for the determining to yield a positive result.

The peripheral area may be an area in the corner of the display of the target device.

According to a third aspect, it is presented a target device comprising a display and the control device according to the second or fifth aspect, wherein the instructions to obtain the first indication comprise instructions that, when executed by the processor, causes the control device to receive the first indication in a signal from the wearable electronic device.

The instructions to display a user interface may comprise instructions that, when executed by the processor, causes the control device to display the user interface on the display of the target device.

The target device may further comprise instructions that, when executed by the processor, causes the control device to obtain at least one further indication of where at least one other user, wearing a wearable electronic device, is looking; and wherein the instructions to display the user interface comprise instructions that, when executed by the processor, causes the control device to only display the user interface when the first indication differs more than a threshold value from all of the at least one further indications.

According to a fourth aspect, it is presented a wearable electronic device comprising a display, a front facing camera, and the control device according to the second or fifth aspect, wherein the instructions to obtain the first indication comprise instructions that, when executed by the processor, causes the control device to determine, using a signal from the front facing camera of the wearable electronic device, where the first user is looking.

The instructions to display a user interface may comprise instructions that, when executed by the processor, causes the control device to display the user interface on the display of the wearable electronic device.

According to a fifth aspect, it is presented a control device comprising: means for obtaining a first indication of where a first user, wearing a wearable electronic device, is looking; means for determining, using the first indication, that the first user is looking at a predefined peripheral area in relation to a display of a target device; and means for displaying a user interface for the target device.

According to a sixth aspect, it is presented a computer program for controlling a target device comprising a display. The computer program comprises computer program code which, when run on the control device causes the control device to: obtain a first indication of where a first user, wearing a wearable electronic device, is looking; determine, using the first indication, that the first user is looking at a predefined peripheral area in relation to the display of the target device; and display a user interface for target device.

According to a seventh aspect, it is presented a computer program product comprising a computer program according to the sixth aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating an environment in which embodiments presented herein can be applied;

FIGS. 2A-C are schematic diagrams illustrating predefined peripheral areas for use to control the target device of FIG. 1;

FIG. 3 is a schematic diagram illustrating some components of a wearable electronic device of FIG. 1;

FIG. 4 is a schematic diagram illustrating some components of a target device of FIG. 1;

FIG. 5 is a schematic diagram illustrating some components of a control device of FIG. 1;

FIGS. 6A-B are flow charts illustrating methods for controlling the target device of FIGS. 1 and 4;

FIGS. 7A-B are sequence diagrams illustrating signalling which can be performed in conjunction with the methods illustrated in FIGS. 6A-B;

FIGS. 8A-C are schematic diagrams illustrating various embodiment of where the control device of FIG. 5 can be embodied;

FIG. 9 is a schematic diagram showing functional modules of the control device of FIG. 5; and

FIG. 10 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

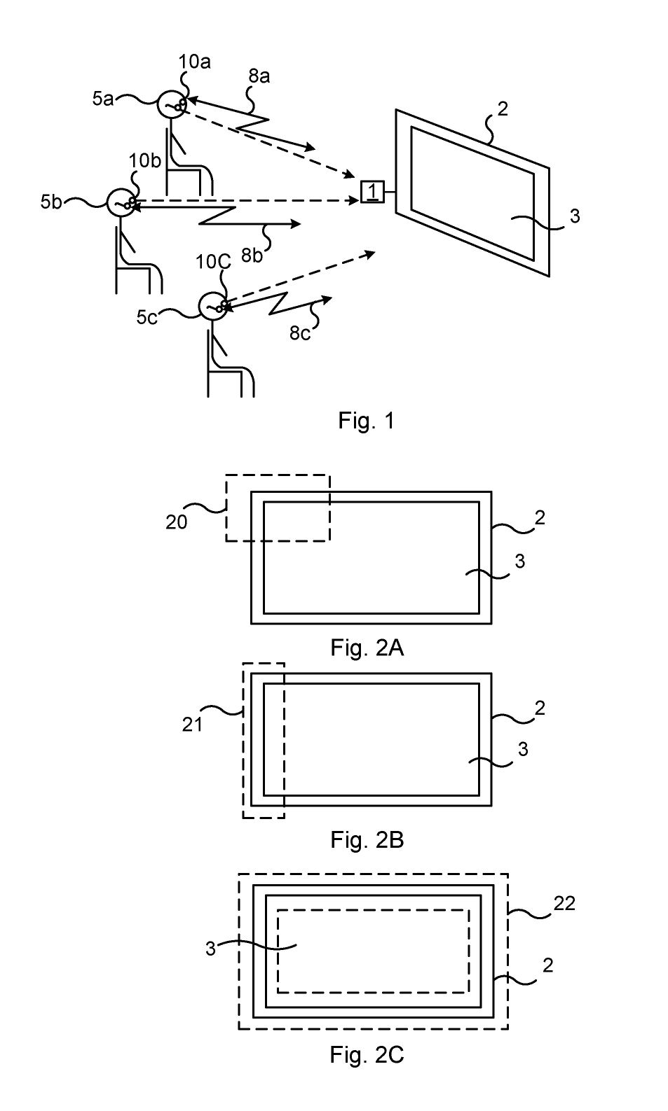

FIG. 1 is a schematic diagram illustrating an environment in which embodiments presented herein can be applied. A target device 2 comprises a display 3. The target device 2 can be any suitable electronic device benefitting from efficient user control. In one embodiment, the target device 2 is a television. In one embodiment, the target device 2 can be a device which provides display data to a television or other display device, in which case the target device could be set top box or similar. In the description below, embodiments are presented with reference to the target device being a television; however, it is to be noted that this does not restrict the target device to only such an embodiment.

In this example there is a first user 5a, a second user 5b and a third user 5c. However, it is to be noted this is only an example and embodiments presented herein can be applied for any number of users.

The first user 5a wears a first wearable electronic device 10a, the second user 5b wears a second wearable electronic device 10b, and the third user 5c wears a third wearable electronic device 10c. Each wearable electronic device 10a-c is worn essentially fixed in relation to the user wearing, e.g. on the head of the respective user. In this way, the direction of each wearable electronic device 10a-c changes when its user moves his/her head to look in a different direction. Hence, the direction of where the user is looking can be determined with some certainty by detecting the direction of where the wearable electronic device 10a-c of the user is pointing. In one embodiment, the wearable electronic devices are in the form of electronic glasses and can for example also have the function of providing a three dimensional (3D) experience of the display 3 of the target device 2, i.e. 3D glasses.

Furthermore, the first wearable electronic device 10a communicates over a first wireless link 8a with a control device 1 for the target device 1 and/or the target device 2, the second wearable electronic device 10b communicates over a second wireless link 8b with the control device 1 and/or the target device 2 and the third wearable electronic device 10c communicates over a third wireless link 8c (or a wired link) with the control device 1 and/or the target device 2. The wireless links 8a-c can be of any suitable current or future type and can e.g. use Bluetooth, wireless USB (Universal Serial Bus), IrDA (Infrared Data Association), WiFi (wireless local area network), etc. Alternatively, the wireless links 8a-c can be replaced with wired links, e.g. using USB, FireWire, Ethernet, etc. The control device 1 can form part of the target device 2 or be separate from the target device.

As is explained in more detail below, any one of the users 5a-c can control a user interface for the target device 2 by turning his/her wearable electronic device 10a-c to point to a peripheral area in relation to the display 3.

FIGS. 2A-C are schematic diagrams illustrating predefined peripheral areas 20 for use to control the target device 2 of FIG. 1. The peripheral area 20 is used for activating a user interface of the target device 2. The peripheral area 20 is not in the centre section of the display 3 and is instead in a peripheral position to reduce any risk of inadvertently activating the user interface. It is to be noted that the peripheral area 20 may be completely inside the boundaries of the display 3, completely outside the boundaries of the display 3 or it may overlap the boundary of the display 3, as long as the position of the peripheral area is defined in relation to the display 3, either directly or indirectly, such as via the target device 2. For example, the peripheral area can be an object of a predefined appearance next to the target device, e.g. a painted object on a wall next to the target device or a decorative object (such as a specific sculpture or similar) close to the target object. It is to be noted that the examples of FIGS. 2A-C are only illustratory and may vary in size and position.

In FIG. 2A, an embodiment is shown where the peripheral area 20 is in one corner (top left in this example) of the display 3. The peripheral area 20 could also be in any other corner of the display 3.

In FIG. 2B, an embodiment is shown where the peripheral area 21 is along one side (left side in this example) of the display 3. The peripheral area 21 could also be along any other of the sides of the display 3.

In FIG. 2C, an embodiment is shown where the peripheral area 22 is along the outline boundary of the display 3.

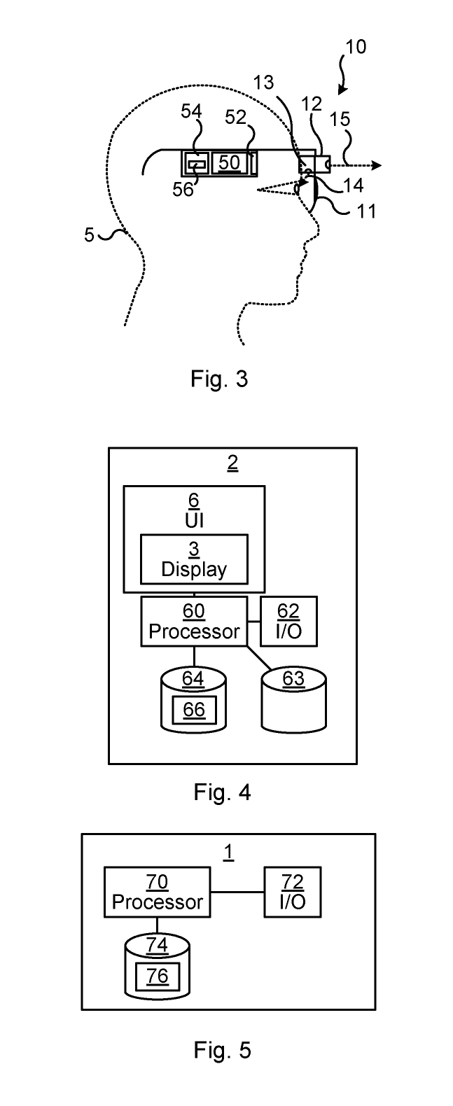

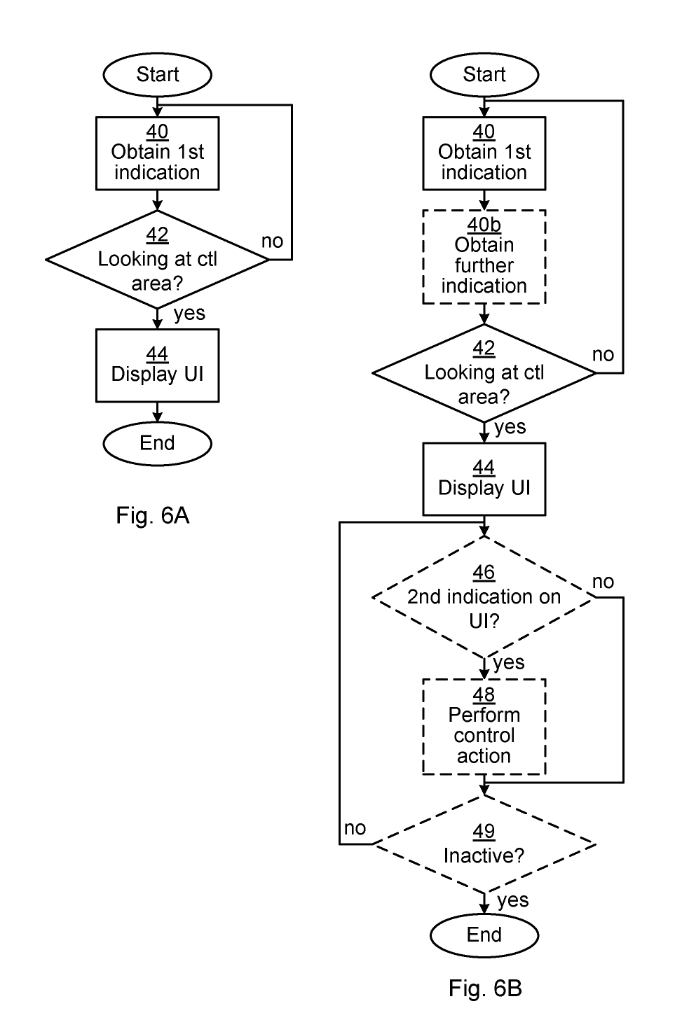

FIG. 3 is a schematic diagram illustrating some components of a wearable electronic device 10 being any one of the wearable electronic devices 10a-c of FIG. 1. A processor 50 is provided using any combination of one or more of a suitable central processing unit (CPU), multiprocessor, microcontroller, digital signal processor (DSP), application specific integrated circuit etc., capable of executing software instructions 56 stored in a memory 54, which can thus be a computer program product. The processor 50 can be configured to execute the methods described with reference to FIGS. 6A-B below.

The memory 54 can be any combination of read and write memory (RAM) and read only memory (ROM). The memory 54 also comprises persistent storage, which, for example, can be any single one or combination of magnetic memory, optical memory, solid state memory or even remotely mounted memory.

The wearable electronic device 10 further comprises an I/O (input/output) interface 52 for communicating with a control unit (1 of FIG. 1) and/or a target device (2 of FIG. 1).

A front facing camera 12 is directed away from a user 5 of the wearable electronic device 10 and is connected to the controller 50.

Signals of the front facing camera 12 comprising images are received by the controller 50. The controller 50 can detect a location of the target device 2 in the image(s). By analysing the location of a reference point (such as a centre point or a corner) of the target device 2 in the image, the controller can determine a direction 15 of where the wearable electronic device 10 is directed, which is an indication of where the user 5 is looking, in relation to the target device 2, and/or in relation to the display of the target device 2.

In order to further refine the detection of where the user 5 is looking, an optional user facing camera 13 can be utilised. The user facing camera 13 is directed 14 towards an eye of the user to track the pupil of the eye. In this way, the controller 50 can dynamically determine where, within the image of the front facing camera 12, the user 5 is looking.

Optionally, the wearable electronic device 10 comprises a display 11. The display may be overlaid on a transparent medium, such as glass and/or transparent plastic, whereby the user 5 can see through the display 11 when the display 11 is inactive. In this way, any information on the display 11 is overlaid real world objects in the viewing field of the user 5.

In one embodiment, the wearable electronic device 10, as shown, is in the form of electronic glasses and can for example also have the function of providing a three dimensional (3D) experience of the display 3 of the target device 2, i.e. 3D glasses.

Other components of the wearable electronic device 10 are omitted in order not to obscure the concepts presented herein.

FIG. 4 is a schematic diagram illustrating some components of a target device 2 of FIG. 1. A processor 60 is provided using any combination of one or more of a suitable central processing unit (CPU), multiprocessor, microcontroller, digital signal processor (DSP), application specific integrated circuit etc., capable of executing software instructions 66 stored in a memory 64, which can thus be a computer program product. The processor 60 can be configured to execute the methods described with reference to FIGS. 6A-B below.

The memory 64 can be any combination of read and write memory (RAM) and read only memory (ROM). The memory 64 also comprises persistent storage, which, for example, can be any single one or combination of magnetic memory, optical memory, solid state memory or even remotely mounted memory.

A data memory 63 can be any combination of read and write memory (RAM) and read only memory (ROM). The data memory 63 may also comprise persistent storage, which, for example, can be any single one or combination of magnetic memory, optical memory, solid state memory or even remotely mounted memory.

The target device 2 further comprises an I/O (input/output) interface 62 for communicating e.g. with a control device (1 of FIG. 1) when present and/or with one or more wearable electronic devices (10a-c of FIG. 1).

A user interface 6 comprises a display 3 and one or more input devices, such as remote control, push buttons, etc. The display 3 can be used to show the output of the user interface 6.

Other components of the target device 2 are omitted in order not to obscure the concepts presented herein.

FIG. 5 is a schematic diagram illustrating some components of a control device 1 of for controlling the target device of FIGS. 1 and 4. When the control device 1 is part of a host device such as the target device 2 or the wearable electronic device 10, the components shown here can be, but do not need to be, shared with the host device.

A processor 70 is provided using any combination of one or more of a suitable central processing unit (CPU), multiprocessor, microcontroller, digital signal processor (DSP), application specific integrated circuit etc., capable of executing software instructions 76 stored in a memory 74, which can thus be a computer program product. The processor 70 can be configured to execute the methods described with reference to FIGS. 6A-B below.

The memory 74 can be any combination of read and write memory (RAM) and read only memory (ROM). The memory 74 also comprises persistent storage, which, for example, can be any single one or combination of magnetic memory, optical memory, solid state memory or even remotely mounted memory.

The control device 1 further comprises an I/O (input/output) interface 72 for communicating e.g. with a target device (2 of FIG. 1) and/or with one or more wearable electronic devices (10a-c of FIG. 1).

FIGS. 6A-B are flow charts illustrating methods for controlling the target device of FIGS. 1 and 4.

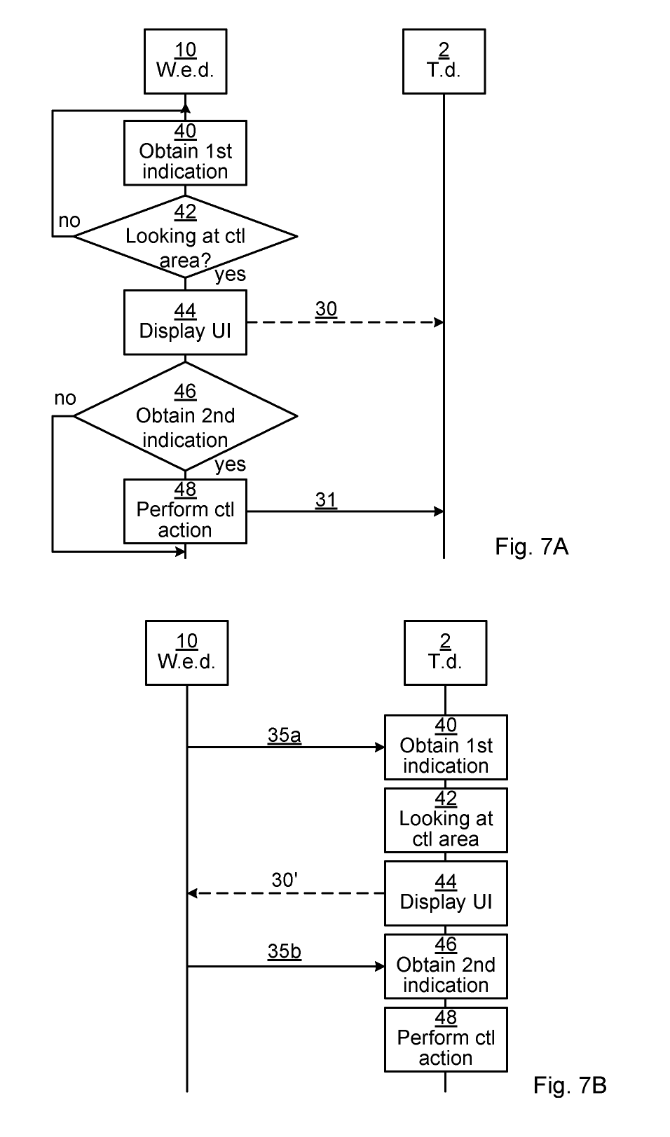

In an obtain first indication step 40, a first indication of where a first user, wearing a wearable electronic device, is looking is obtained. The first indication can e.g. be received in a signal from the wearable electronic device as shown in FIG. 7B.

When the control device is comprised in the wearable electronic device and the wearable electronic device comprises a display and a camera configured to be directed away from a user of the wearable electronic device, the camera can provide a signal from which it can be determined where the first user is looking, in relation to the display of the target device.

In a conditional looking at control area step 42, it is determined, using the first indication, whether the first user is looking at a predefined peripheral area in relation to the display of the target device. This can e.g. be done by analysing image(s) of the first indication to recognise that the user is looking at the predefined peripheral area.

In one embodiment, the determination is only positive when the user is looking at the predefined area more than a threshold amount of time. In this way, the risk of accidental activation of the UI (User Interface) is reduced. The threshold amount of time can be configurable by the manufacturer of the target device and/or by the user. As explained above with reference to FIGS. 2A-C above, the peripheral area can be an area in the corner, along one side, along any side or even outside the display of the target device.

When this determination is positive, the method proceeds to the display UI step 44. Otherwise, the method returns to the obtain first indication step 40.

In one embodiment, the user needs to look at a predefined sequence of locations within a certain amount of time for this determination to be positive, e.g. top left corner, bottom right corner and top left corner again within one second. In this way, the risk of accidental activation is reduced even further.

In the display UI step 44, the user interface for the target device is displayed. The user interface can be displayed on the display of the target device. Alternatively or additionally, the user interface is displayed on the display of the wearable electronic device. When the user interface is only displayed on the target device, the requirements of the wearable electronic device is greatly relaxed, since there is no need for the wearable electronic device to comprise a display. This is a significant cost saver. Moreover, all users watching the target device 2 are made aware of the commands that may be about to be triggered, and may also see a feedback of the triggering of such a command.

FIG. 6B is a flow chart illustrating a method similar to the method illustrated in FIG. 6A. Only new steps or steps which are modified compared to the method illustrated in FIG. 6A will be described below.

In an optional obtain further indication step 40b at least one further indication is obtained. The further indication indicates where at least one other user, wearing a wearable electronic device, is looking.

In such a case, the conditional looking at control area step 42 is only determined to be true when the first indication differs more than a threshold value from all of the at least one further indications. This prevents activation of the UI in case a key part of the action shown on the display happens to occur in one corner of the display of the target device.

In a conditional second indication on UI step 46, a second indication of where the first user is looking is obtained, e.g. in the same manner as explained above for the first indication. The control device then compares the direction with locations of user interface elements of the UI displayed in the display UI step 44. When the direction indicates that the first user is looking at a user interface element, the method proceeds to a perform control action step 48. Otherwise, the method proceeds to a conditional inactive step 49. In one embodiment, this determination is only positive when the user is looking at the predefined area more than a threshold amount of time to prevent accidental triggering of a control action.

In the perform control action step 48, a control action of the target device is performed when the second indication indicates that the first user is looking at a user interface element of the user interface. Control actions can e.g. be any command of a traditional remote control, such as channel selection (channel up/down), volume control, electronic programming guide navigation, etc.

In the conditional inactive step 49, the control device determines whether there is inactivity of the first user. This can e.g. be indicated by the user not having looked in the direction of the UI during a certain amount of time. If inactivity is determined, the method ends. Otherwise, the method returns to the conditional second indication on UI step 46 to process more commands from the first user.

FIGS. 7A-B are sequence diagrams illustrating signalling which can be performed in conjunction with the methods illustrated in FIGS. 6A-B.

In FIG. 7A, an embodiment is shown where the method is performed in the wireless electronic device 10. Here, it is the wireless electronic device 10 which determines the direction of where the user is looking and based on this, determines if the user is looking at the predefined peripheral area.

In the display UI step 44, the UI can be displayed in the wireless electronic device 10 and/or the target device 2, as explained above. When the target device 2 is to display the UI, a signal 30 is sent from the wireless electronic device 10 to the target device 2 to display the UI.

In the perform control action step 48, when a control action is determined, a command 31 is sent to the target device to perform the action, such as to change channel, adjust volume up/down, etc.

In FIG. 7B, an embodiment is shown where the method is performed in the target device 2. Here, it is the target device 2 which determines the direction of where the user is looking and based on this, determines if the user is looking at the predefined peripheral area.

In the obtain first indication step 40, the first indication is received in a signal 35a from the wearable electronic device 10.

In the display UI step 44, the UI can be displayed in the wireless electronic device 10 and/or the target device 2, as explained above. When the wireless electronic device 10 is to display the UI, a signal 30′ is sent from the target device 2 to the wireless electronic device 10 to display the UI.

In the obtain second indication step 46, the second indication is received in a signal 35b from the wearable electronic device 10.

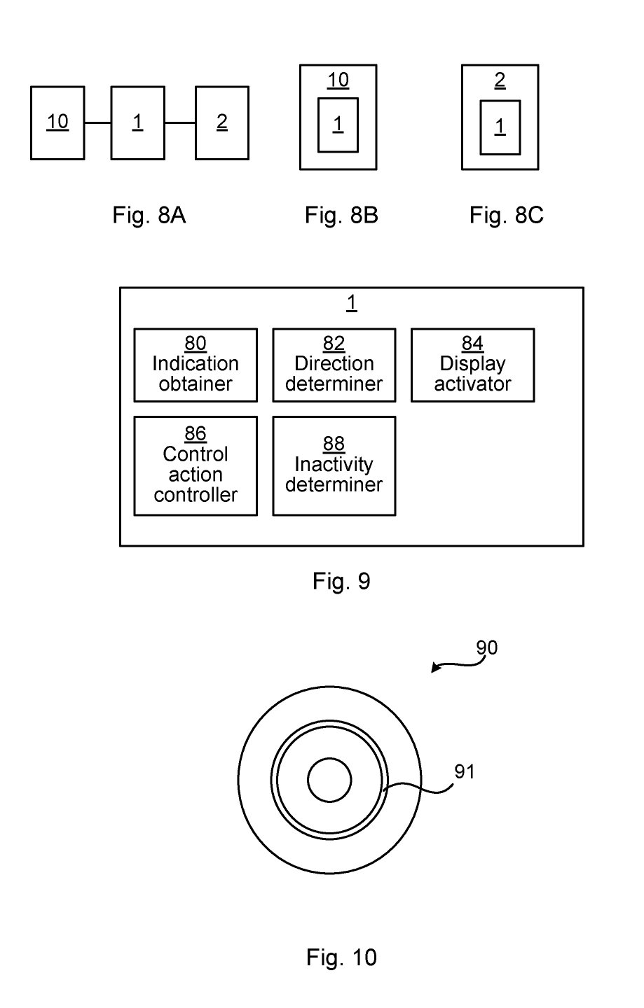

FIGS. 8A-C are schematic diagrams illustrating various embodiment of where the control device 1 of FIG. 5 can be embodied.

In FIG. 8A, an embodiment is shown where the control device 1 is a stand alone device which is connected to the wearable electronic device 10 and the target device 2.

In FIG. 8B, an embodiment is shown where the control device 1 is located in the wearable electronic device 10. In this embodiment, the wearable electronic device 10 is a host device for the control device 1.

In FIG. 8C, an embodiment is shown where the control device 1 is located in the target device 2. In this embodiment, the target device 2 is a host device for the control device 1.

Optionally, different control devices 1 or different parts of the control device 1 can be housed in multiple host devices, e.g. partly in a wearable electronic device and partly in a target device.

FIG. 9 is a schematic diagram showing functional modules of the control device 1 of FIG. 5. The modules are implemented using software instructions (e.g. 56 of FIG. 3, 66 of FIG. 4 and/or 76 of FIG. 5) executing in the control device 1. The modules correspond to the steps in the methods illustrated in FIGS. 6A-B.

An indication obtainer 80 is arranged to indicate indications of where a user is looking. This module corresponds to the obtain first indication step 40 of FIG. 6A and obtain further indication step 40b of FIG. 6B.

A direction determiner 82 is arranged to determine when a user is looking at a predefined peripheral area. This module corresponds to the conditional looking at control area step 42 of FIGS. 6A-B and the conditional second indication on UI step 46 of FIG. 6B.

A display activator 84 is arranged to display a user interface for the target device. This module corresponds to the display UI step of FIGS. 6A-B.

A control action controller 86 is arranged to perform control actions of the target device. This module corresponds to the perform control action step 48 of FIG. 6B.

An inactivity determiner 88 is arranged to determine when the user or users are inactive. This module corresponds to the conditional inactive step 49 of FIG. 6B.

FIG. 10 shows one example of a computer program product comprising computer readable means. On this computer readable means a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 56 of FIG. 3, the computer program product 66 of FIG. 4 or the computer program product 76 of FIG. 5. While the computer program 91 is here schematically shown as a track on the depicted optical disk, the computer program can be stored in any way which is suitable for the computer program product.

The invention has mainly been described above with reference to a few embodiments. However, as is readily appreciated by a person skilled in the art, other embodiments than the ones disclosed above are equally possible within the scope of the invention, as defined by the appended patent claims.

1. A method for controlling a target device comprising a display, the method being performed in a control device and comprising the steps of:
obtaining a first indication of where a first user, wearing a wearable electronic device, is looking;
determining, using the first indication, that the first user is looking at a predefined peripheral in relation to the display of the target device; and
displaying a user interface for the target device.

2. The method according to claim 1, further comprising the steps of:
obtaining a second indication of where the first user is looking; and
performing a control action of the target device when the second indication indicates that the first user is looking at a user interface element of the user interface.

3. The method according to claim 1, wherein the step of determining that the first user is looking at predefined peripheral area requires that the user is looking at the predefined area more than a threshold amount of time for the determining to yield a positive result.

4. The method according to claim 1, wherein the peripheral area is an area in the corner of the display of the target device.

5. The method according to claim 1, wherein the control device is comprised in the target device, and wherein:
the step of obtaining the first indication comprises receiving the first indication in a signal from the wearable electronic device.

6. The method according to claim 5, wherein the step of displaying a user interface comprises displaying the user interface on the display of the target device.

7. The method according to claim 5, further comprising the step of:
obtaining at least one further indication of where at least one other user, wearing a wearable electronic device, is looking; and
wherein the step of displaying the user interface is only performed when the first indication differs more than a threshold value from all of the at least one further indications.

8. The method according to claim 1, wherein the control device is comprised in the wearable electronic device comprising a display and a front facing camera, and wherein:
the step of obtaining the first indication comprises determining, using a signal from the front facing camera of the wearable electronic device, where the first user is looking.

9. The method according to claim 8, wherein the step of displaying a user interface comprises displaying the user interface on the display of the wearable electronic device.

10. A control device for controlling a target device comprising a display, the control device comprising:
a processor; and
a memory storing instructions that, when executed by the processor, causes the control device to:
obtain a first indication of where a first user, wearing a wearable electronic device, is looking;
determine, using the first indication, that the first user is looking at a predefined peripheral area in relation to the display of the target device; and
display a user interface for target device.

11. The control device according to claim 10, further comprising instructions that, when executed by the processor, causes the control device to: obtain a second indication of where the first user is looking; and to perform a control action of the target device when the second indication indicates that the first user is looking at a user interface element of the user interface.

12. The control device according to claim 10, wherein the instructions to determine that the first user is looking at predefined peripheral area comprise instructions that, when executed by the processor, causes the control device to require that the user is looking at the predefined area more than a threshold amount of time for the determining to yield a positive result.

13. The control device according to claim 10, wherein the peripheral area is an area in the corner of the display of the target device.

14. A target device comprising a display and the control device according to claim 10, wherein the instructions to obtain the first indication comprise instructions that, when executed by the processor, causes the control device to receive the first indication in a signal from the wearable electronic device.

15. The target device according to claim 14, wherein the instructions to display a user interface comprise instructions that, when executed by the processor, causes the control device to display the user interface on the display of the target device.

16. The target device according to claim 14, further comprising instructions that, when executed by the processor, causes the control device to obtain at least one further indication of where at least one other user, wearing a wearable electronic device, is looking; and wherein the instructions to display the user interface comprise instructions that, when executed by the processor, causes the control device to only display the user interface when the first indication differs more than a threshold value from all of the at least one further indications.

17. A wearable electronic device comprising a display, a front facing camera, and the control device according to claim 10, wherein the instructions to obtain the first indication comprise instructions that, when executed by the processor, causes the control device to determine, using a signal from the front facing camera of the wearable electronic device, where the first user is looking.

18. The wearable electronic device according to claim 17, wherein the instructions to display a user interface comprise instructions that, when executed by the processor, causes the control device to display the user interface on the display of the wearable electronic device.

19. A control device comprising:
means for obtaining a first indication of where a first user, wearing a wearable electronic device, is looking;
means for determining, using the first indication, that the first user is looking at a predefined peripheral area in relation to a display of a target device; and
means for displaying a user interface for the target device.

20. A computer program product comprising a non-transitory computer readable storage medium storing computer program code for controlling a target device comprising a display, the computer program code when run on the control device causes the control device to:
obtain a first indication of where a first user, wearing a wearable electronic device, is looking;
determine, using the first indication, that the first user is looking at a predefined peripheral area in relation to the display of the target device; and
display a user interface for target device.

21. (canceled)
